(19) United States
(12) Patent Application Publication
(10) Pub. No.: US 2006/0095551 A1
(43) Pub. Date: May 4, 2006

(54) Extensible service processor architecture

(76) Inventors: John Chun Kwak Leung, Folsom, CA (US); David Durham, Hillsboro, OR (US); Raj Yavatkar, Portland, OR (US); Milan Milenkovic, Portland, OR (US); Mark Doran, Olympia, WA (US); Greg Gans, Portland, OR (US); Paul Crutcher, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/976,625

(22) Filed: Oct. 29, 2004

(51) Int. Cl. G06F 15/173

(52) U.S. Cl. 709/223

(57) ABSTRACT

Embodiments of the invention are generally directed to a system and method for a service processor architecture. The service processor provides an extensible execution environment for a platform (or other device) that is accessible when the host system is non-functional. In an embodiment, the service processor has one or more platform-independent external interfaces to provide a communications link between the service processor and one or more management resources.

### TECHNICAL FIELD

Embodiments of the invention generally relate to the field of information processing and, more particularly, to a system and method for a service processor architecture.

### BACKGROUND

Many conventional computing platforms provide access to manageability functions through a platform-dependent management interface. These platform-dependent management interfaces may enable a local or remote entity (human or machine) to monitor and manage platform characteristics such as temperature, voltage, system status, and the like. One example of a platform-dependent management interface is the interface described in the Intelligent Platform Management Interface (IPMI) v1.5 Specification available from Intel, Corporation. The IPMI specification defines interfaces to manage network server platforms and telephone company equipment.

Since conventional management interfaces are platform-dependent, different platforms are typically designed to work with different management interfaces. For example, a cell phone may be designed to work with a first management interface and a server may be designed to work with a second interface. Platform vendors and other enterprises are compelled to create a variety of connectors to integrate various platforms with the appropriate platform-dependent management interfaces. The development of these connectors increases the effort required to develop a given platform. In addition, the various platform-dependent management interfaces compel software vendors to support multiple and sometimes inconsistent management interfaces. Platform-dependant management interfaces typically provide a customer with inconsistent sets of core management capabilities that must be separately maintained over time.

Many conventional computing platforms provide access to manageability finctions on the host operating system and applications which execute on the host operating system through a software agent, which itself executes on the host operating system. This is problematic since the manageability of these components is dependent on the health of the major component, the host operating system, itself. One example of the problems that can arise is when a management console loses network connection to a software agent that is running on the host system. The management console must deduce whether the dropped connection is because of a failure of the software agent, failure of the operating system, failure of the network driver, or failure of the hardware. In additional, the management console must further deduce whether the failure is caused by an operational fault or an intentional reset or reboot of a component. If the management console incorrectly deduces the cause of the dropped connection, it may embark upon unnecessary courses of action, if any.

Conventional computing platforms cannot be managed when the operating system is disabled. That is, conventional computing platforms cannot be managed when, for example, they are under attack (e.g., from viruses, malware, etc.), suspended, overloaded, etc. Moreover, in conventional computing platforms, diagnostics and repair cannot be performed when the operating system is disabled.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a high-level block diagram of a platform implemented according to an embodiment of the invention.

FIG. 2 is a block diagram illustrating selected aspects of the external interface subsystem of a service processor according to an embodiment of the invention.

FIG. 3 is a conceptual diagram illustrating the relationships between selected aspects of a service processor, according to an embodiment of the invention.

FIG. 4 is a block diagram of an external interface subsystem, implemented according to an embodiment of the invention.

FIG. 5 is a block diagram illustrating selected aspects of discovering and extending a service processor, according to an embodiment of the invention.

FIG. 6 is a block diagram illustrating selected aspects of a sensor-effector interface (SEI) subsystem, according to an embodiment of the invention.

FIG. 7 is a conceptual diagram illustrating a service processor gathering managed data from resource data records, according to an embodiment of the invention.

FIG. 8 is a flow diagram illustrating certain aspects of a method for using a service processor, according to an embodiment of the invention.

### DETAILED DESCRIPTION

Embodiments of the invention are generally directed to a system and method for a service processor architecture. The service processor provides an extensible execution environment for a platform (or other device) that is accessible when the host system is non-functional. In an embodiment, the service processor has one or more platform-independent external interfaces to provide a communications link between the service processor and one or more management resources. These platform independent interfaces provide a common manageability interface suitable for nearly any platform. This common manageability interface may, for example, simplify platform development, reduce the number of management interfaces that must be supported, and provide a consistent set of core manageability capabilities to an end-user.

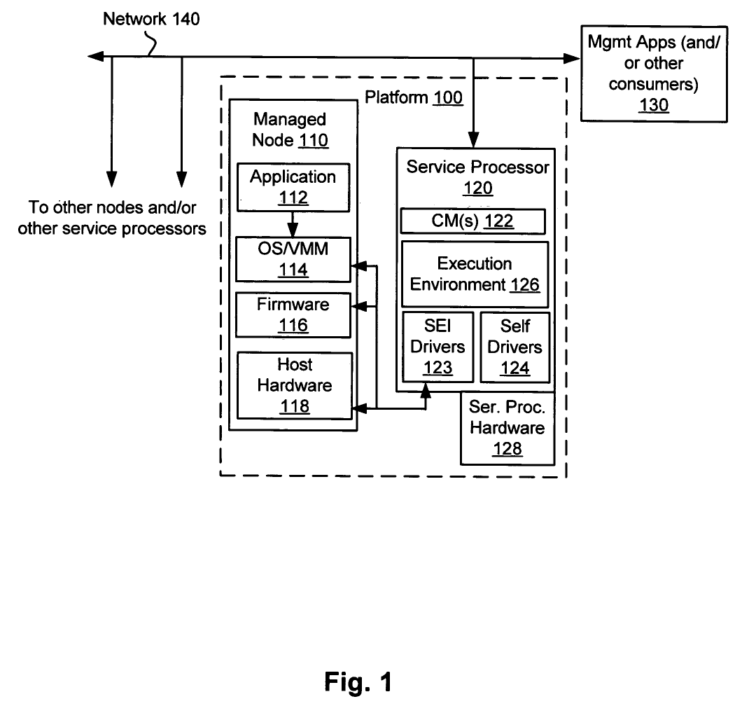

FIG. 1 is a high-level block diagram of platform 100 implemented according to an embodiment of the invention. The term “platform” broadly refers to, for example, a server, a desktop, a laptop, a network infrastructure component (e.g., switch, router, etc.), a handheld device, a cell phone, and the like. Platform 100 includes managed node 110 and service processor 120. In an embodiment, service processor 120 is co-located with managed node 110 on platform 100 but, as is further described below, is independent of operating system (or virtual machine or virtual machine manager) 114. Management application 130 (or other third parties) may use service processor 120 to manage platform 100 including managed node 110.

Managed node 110 provides the hardware, operating system, and/or applications of a host system for platform 100. In the illustrated embodiment, managed node 110 includes application 112, operating system (or virtual machine or virtual machine manager) 114, firmware (e.g., basic input/output system (BIOS) firmware) 116, and host hardware 118 (e.g., host control logic, system memory, persistent storage, network interface, etc.). In alternative embodiments, managed node 110 may have more elements, fewer elements, and/or different elements.

Service processor 120 includes pluggable logic modules (e.g., 122-124), execution environment 126, and service processor hardware 128. Execution environment 126 provides a core set of services to support the pluggable logic modules (e.g., 122-124). In an embodiment, execution environment 126 is “always” available. The term “always available” indicates that execution environment 126 is independent of the state of operating system (OS) 114. In some embodiments, execution environment 126 is available when managed node 110 is in a low power state (e.g., sleep or suspend). This availability allows service processor 120 to be used to manage the platform before OS 114 is present or when OS 114 is unavailable, corrupted, or potentially compromised. In an embodiment, platform 100 can be patched, repaired, or completely reprovisioned via service processor 120. Also, the configuration of OS 114 and/or application 112 may, in some embodiments, be re-established.

In an embodiment, execution environment 126 can be extended by downloading pluggable logic modules such as capability module(s) 122, sensor-effector drivers 123, and self drivers 124. Capability module(s) 122 are pluggable modules of logic that provide management functionality. The term “pluggable” refers to logic that can be downloaded (and/or removed) and that draws on the core services provided by execution environment 126. Sensor-effector drivers 123 provide modular and extensible logic to manage the hardware and software of managed node 110. Self drivers 124 are modules of logic that are used to control and manage hardware that is assigned as part of a pool of available resources for service processor 120 (e.g., service processor hardware 128). In one embodiment, execution environment 126 is dynamically accessible. That is, the pluggable logic modules can be downloaded to service processor 120 and loaded onto execution environment 126 without rebooting service processor 120.

Management application 130 broadly represents an application to manage one or more hardware and/or software elements of platform 100 via service processor 120. In the illustrated embodiment, management application 130 is a remote application that accesses service processor 120 through network 140. Network 140 may be, for example, any combination of a wired or wireless network and may include any combination of a Local Area Network (LAN), a Wide Area Network (WAN), a Metropolitan Area Network (MAN), an intranet, and/or the Internet. In an embodiment, a management application resident on platform 100 (not shown) may also manage platform hardware and/or software via service processor 120.

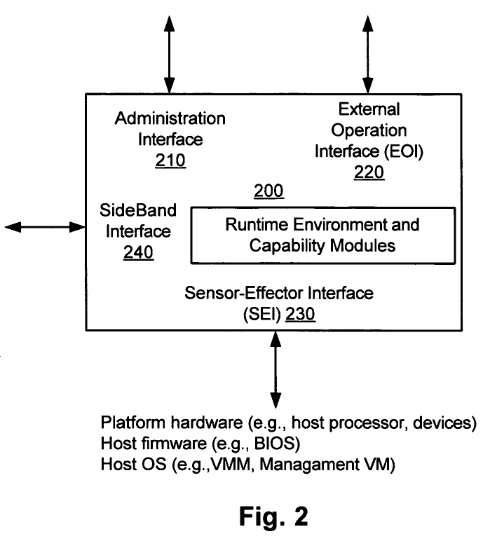

In one embodiment, the architecture of service processor 120 is primarily defined by a number of external interfaces. The reason for this is that, while certain aspects of service processor 120 vary depending on its implementation, the external interfaces describe how entities external to service processor 120 will interact with it. FIG. 2 is a block diagram illustrating selected aspects of external interface subsystem 200 of a service processor according to an embodiment of the invention. External interface subsystem system 200 includes, administration interface 210, external operations interface (EOI) 220, sensor/effector interface 230, and side-band interface 240. In an alternative embodiment, external interface subsystem 200 may include more interfaces, fewer interfaces, and/or different interfaces.

Administrative interface 210 is used by an external entity to manage the service processor itself. Examples of external entities include, and are not limited to, an enterprise management system or an information technology (IT) operator. Managing the service processor includes, for example, configuring the external interfaces of subsystem 200 and managing the security of the service processor. In one embodiment, administrative interface 210 is used to download the pluggable logic modules (e.g., 122-124, shown in FIG. 1) and/or controlling the pluggable logic modules.

In one embodiment, the primary interface format for administrative interface 210 is based on the Simple Object Access Protocol (SOAP). The SOAP protocol refers to any of the SOAP protocols including the protocol promulgated by the World Wide Web Consortium (W3C) entitled, “SOAP Version 1.1 Part 1: Messaging Framework and Part 2: Adjuncts,” 24 Jun. 2003 (hereinafter, the SOAP protocol). In one embodiment, the eXtenisble Markup Language (XML) is used to define the data in the SOAP messages. XML refers to any of the XML definitions including the one promulgated by the W3C entitled, “Extensible Markup Language (XML) 1.0 (Second Edition),” 6 Oct. 2000. In such an embodiment, the primary interface format may be referred to as SOAP/XML.

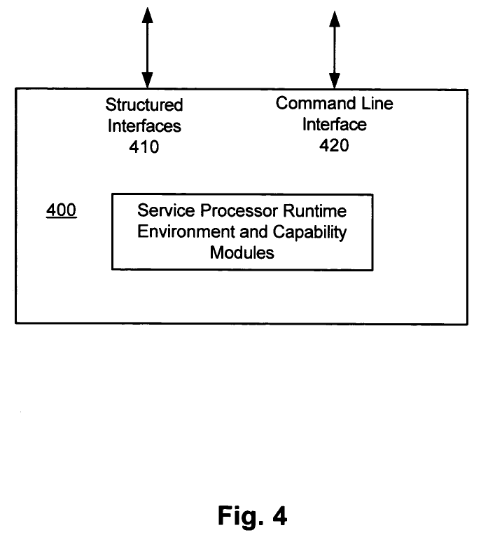

External operations interface (EOI) 220 is used by an external enterprise to manage the host node (e.g., managed node 110, shown in FIG. 1) that is associated with the service processor (e.g., service processor 120, shown in FIG. 2). As is further discussed below, EOI 220 can be extended by downloading capability modules (e.g., capability modules 122, shown in FIG. 1). In one embodiment, the primary interface format for EOI 220 is SOAP/XML. Administrative interface 210 and EOI 220 are further discussed below with reference to FIG. 4.

In one embodiment, sideband interface 240 is used to provide private service processor to service processor communication with a group of service processors. This sideband communication may be used among service processors that are functionally related and/or in close proximity to each other. For example, sideband interface 240 may be used for early detection of anomalies that affect clusters of managed nodes. Similarly, sideband interface 240 may be used to support group decision making, distributed events, and/or data correlation in hierarchies of service processors.

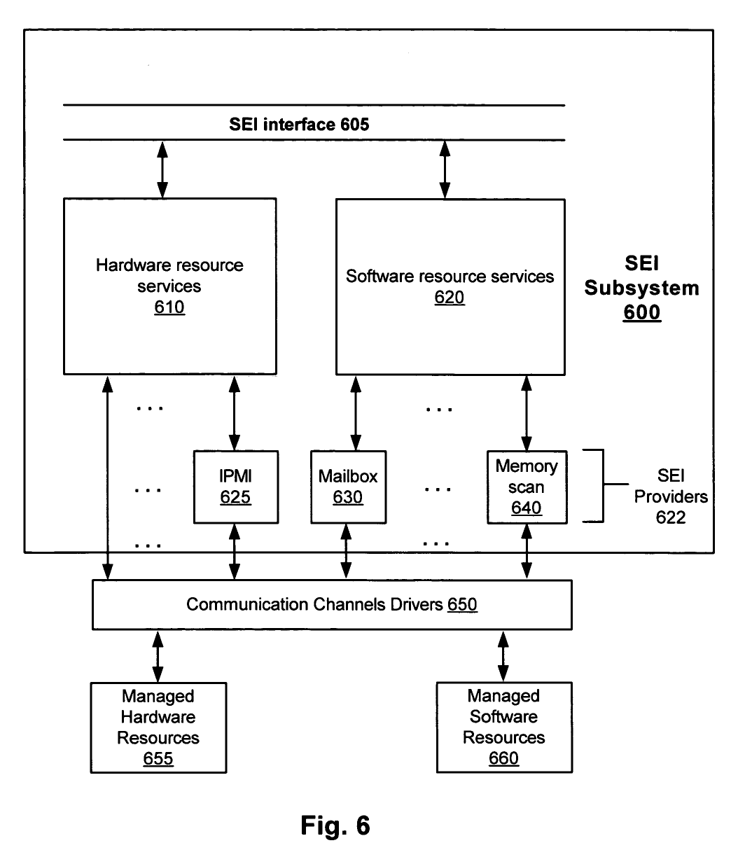

In an embodiment sensor-effector interface 230 is used to provide visibility and control of the local platform (e.g., platform 100, shown in FIG. 1) to the capability modules (e.g., capability modules 122, shown FIG. 1). The elements of the platform that may be monitored and/or controlled include hardware (e.g., control logic, memory, network interface, etc.) and/or software (e.g., BIOS, firmware, host OS, etc.). Sensor-effector interface 230 is further discussed below with reference to FIG. 6.

The term “method” refers to the declaration/prototype of a particular function. A method may define the number and types of each input and output argument as well as a set of semantics that describe the effects of invoking the method with parameter values that are contemplated by the syntactic form of the method.

The term “interface” refers to a collection of methods that are thematically related and that may be used to manipulate a set of shared instance data. In one embodiment, code manipulates instance data via methods that are defined for the interface. Interface definitions typically lack attributes, states, or associations; they only have methods.

In one embodiment, interfaces are named by a Globally Unique Identifier (GUID) to ensure that they are uniquely identifiable. In such an embodiment, a GUID refers to a specific set of syntax and semantics. A change or update to the syntax or semantics would imply that a different GUID should be used—this means in practice that a GUID name for an interface also specifies the revision of its definition. Different interfaces that share no syntax or semantics use different GUID names. Use of GUIDs in this way allows consumer code to be sure it is requesting access to an interface that it understands and can use safely. Furthermore, use of GUIDs for this purpose ensures that third parties defining extensions that export their own interfaces can name them without fear of colliding with other third parties doing similar work and without requiring an industry wide “registry” of interface names.

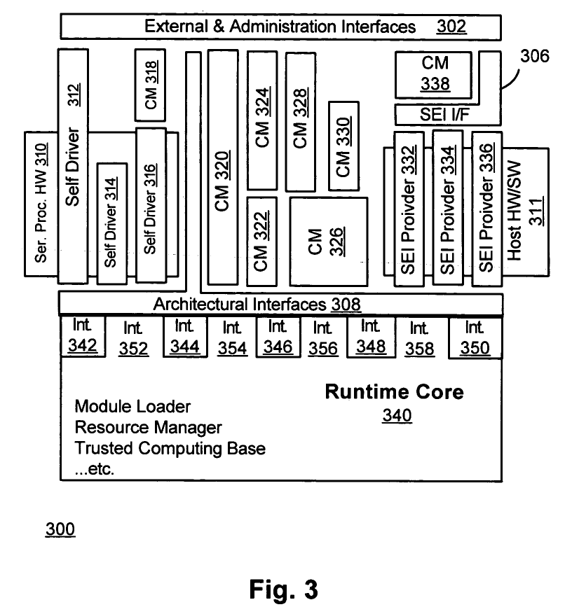

FIG. 3 is a conceptual diagram illustrating the relationships between selected aspects of service processor 300 according to an embodiment of the invention. Service processor 300 includes external and internal interfaces 302-308, pluggable logic components 312-338, service processor hardware 310, and runtime core 340. In an alternative embodiment, service processor 300 may have more elements, fewer elements, and/or different elements.

Runtime core 340 organizes and controls the flow of execution when service processor 300 is running. Runtime core 340 is where execution of the system begins on startup and, among other things, it is responsible for the initial assembly of the component parts of an implementation into a running system. Runtime core 340 provides functionality such as resource management, maintenance of security policy and settings, and execution flow control. In addition, runtime core 340 implements interface linking and binding.

Architectural interfaces 308 link the services provided runtime core 340 to pluggable logic modules 312-338. In an embodiment, one or more of architectural interfaces 308 may be exposed externally via appropriate SOAP/XML abstractions, as is indicated by the confluence of architectural interfaces 308 with external and administrative interfaces 302. In an embodiment, architectural interfaces 308 include interfaces that are implemented as modules of code (e.g., 342-250) and interfaces that are not implemented as a module (e.g., 352-358). The reason for this is that some code is present, (e.g., for bootstrapping purposes) before a module is executed.

The term “module” refers to the smallest grain of implementation that can be loaded by runtime core 340 for execution as part of service processor 300. A module is built and packaged in such a way as to be separately distributed, provisioned, and loaded. A module may contain the implementation of one or more interfaces (e.g., interfaces 302-308). For example, it can be useful to implement two revisions of one interface that share substantial amounts of code in a single module (e.g., to advertise more than one set of operational semantics). In an embodiment, a module contains a list of the interfaces on which it depends for correct operation as well as a list of any interfaces it exposes as part of its own implementation.

In an embodiment, service processor 300 is built into a platform (e.g., platform 100, shown in FIG. 1). The platform hardware may be divided into two logical domains of operation: service processor hardware 310 and host hardware/software 311. Service processor hardware 310 includes the hardware that service processor 300 owns for its own operation. Host hardware/software 311 includes hardware that is owned by the host operating system and application(s).

In an embodiment, sensor-effector (SEI) providers 332-336 monitor and manage host hardware/software 311. SEI providers 332-336 typically access the services of runtime core 340 through architectural interfaces 308. SEI providers 332-336 may also provide interfaces to one or more capability modules (e.g., capability module 338). In addition SEI providers 332-336 may be consumers of interfaces to reach one or more input/output (I/O) devices through one or more I/O busses.

In an embodiment, self drivers 312-316 are modules of code that control and manage service processor hardware 310. For example, self drivers 312-316 may provide drivers to manage control logic, I/O devices, and other hardware assigned to service processor 300. Self drivers 312-316 may provide an abstraction layer that allows the access to hardware 310 to be portable from one service processor instance to another service processor instance. Self drivers 312-316 typically provide device access to runtime core 340. In addition, self drivers 312-316 may export interfaces to a capability module (e.g., capability module 318). In some cases, one or more of self drivers 312-316 are designed to be used exclusively by runtime core 340 (e.g., self driver 314).

Capability modules 318-330 and 338 are implementations of code that participate in the logical operation of service processor 300. For example, capability modules 318-330 and 338 may provide manageability functionality to monitor and manage one or one hardware and/or software resources. The arrangement of capability modules 318-330 and 338 shown in FIG. 3 is an arbitrary example of how a capability module payload might look. In practice, the payload of capability modules may vary considerably by instance and intended purpose of the platform owner. A fixed payload of module content may be the only model supported on some instances of service processor 300. In an embodiment, the functionality of service processor 300 can be extended by adding one or more capability modules, self drivers, and/or SEI providers. In such an embodiment, one or more of the capability modules, self drivers, and/or SEI providers may be developed by one or more third parties.

In an embodiment, service processor 300 is characterized by a number of groupings of interfaces such as external and administrative interfaces 302, SEI interfaces 306, and architectural interfaces 308. External and administrative interfaces 302 are further described below with reference to FIG. 4 and SEI interfaces are further described below with reference to FIG. 6.

FIG. 4 is a block diagram of external interface subsystem 400, implemented according to an embodiment of the invention. External interface subsystem 400 includes structured interfaces 410 and command line interface 420. In an embodiment, the external interfaces provided by subsystem 400 are discoverable and network-addressable entry points to access functionality provided by a service processor. For example, externally visible interfaces may be exposed as web services that are accessed via SOAP/XML over a supported transport protocol such as the HyperText Transfer Protocol (HTTP), the HTTP secured through the Secure Socket Layer (HTTPS), and the like. The HTTP protocol refers to any of the HTTP protocols including, for example, the protocol described in Request For Comments (RFC) 2616 entitled, “HyperText Transport Protocol—HTTP/1.1,” June 1999 (hereinafter, the HTTP protocol). The Secure Socket Layer protocol refers to any of the Secure Socket Layer protocols including, for example, the protocol entitled, “The SSL Protocol Ver. 3.0,” Nov. 18, 1996 (the HTTPS protocol).

In an embodiment, the Web Services Description Language (WSDL) is used to describe the external interfaces and the messaging used to interact with the service. The WSDL documents may reside the platform or may reside in a location remote from the platform (e.g., on a web server). Exposing the external interfaces as web services refers to using SOAP as a messaging protocol for remote service invocation and XML as the data and type definition language. It does not, however, imply a requirement for discovery of an interface to comply with one of the Universal, Discovery, Description, and Integration of Web services (UDDI) specifications, for example, UDDI Version 3.0, Published Specification, Dated 19 Jul. 2002 (hereinafter, the UDDI specification). That is, discovery of the external interface may or may not occur according to the UDDI specification.

Exposing the external interfaces as web services enables runtime binding of clients to the services provided by a service processor. This allows for the decoupling of development and the elimination of design-time dependencies of services provided by a service processor and its users. In addition, exposing the external interfaces as web services supports standards compliance and platform independence/interoperability of a service processor.

In an embodiment, the service processor runtime provides the machinery for handling the SOAP protocol and for serializing and de-serializing XML encoded data on its way in and out of the service processor. In general, well-formed SOAP messages are parsed to extract service processor internal function calls and their parameters (e.g., by de-serializing their XML representation). The service processor runtime core then issues the corresponding function calls locally, manages the related execution, and provides return results back to the SOAP/XML layer for encoding and securing the reply to be forwarded to the external requester.

Command line interface 420 supports accessing a service processor (e.g., service processor 300, shown in FIG. 3) through a text based command line protocol. For example, command line interface 420 may support one or more of the protocols specified by the Distributed Management Task Force (DMTF). In an embodiment, the command line protocol is a request-response protocol that may be used by a human operator and/or a remote scripting language.

Structured interfaces 410 provide the external communications link between a platform and the external world via a messaging/programmatic protocol. Structured interfaces 410 may include administrative interfaces (e.g., administrative interface 210, shown in FIG. 2) and/or external operations interfaces (e.g., EOI 220, shown in FIG. 2). The administrative interfaces allow a service processor to be managed by an external entity. Examples of the services available through the administrative interfaces include: provisioning services (e.g. loading and unloading a capability module), runtime state services (e.g., start and stop), access control services, message security services, system information services, platform integrity services, security context services, storage services, and/or logging (and eventing) services. The EOIs allow external entities to access and control service processor functionality that affect the host platform. Examples of the services available through the EOIs include: interface discovery/introspection services, runtime remotely accessible services, sensor/effector services, and/or external baseline services (see below).

The term “external baseline services” refers to service processor functions that may be invoked externally (e.g., through an EOI) and that target the managed node (e.g., managed node 110, shown in FIG. 1) associated with the service processor. The exact makeup of the external baseline services may vary from instance to instance. Examples of external baseline services include: discovery and (machine readable) description of the managed node; configuration and provisioning of the managed node; status/health monitoring/reporting of the managed node; asset management of the managed node; setting the operational state of the managed node (e.g., host OS booting, up, down); setting the hardware power state of the managed node; and/or fault detection and prediction for the managed node.

In an embodiment, the external interfaces (e.g., structured interfaces 410 and command line interfaces 420) are machine discoverable and self-describing interfaces that use messaging to interact with external entities. Discoverability may be separated into a service processor discovery stage followed by a service discovery stage that provides for enumeration of all services available at the discovered node. The self-describing aspect refers to the machine description of service interfaces in terms of its operations, parameters, and formats that are provided, for example, as WSDL documents.

In an embodiment, a light weight discovery mechanism such as the Service Location Protocol (SLP) may be used to discover a service processor. The SLP refers to any of the service location protocols including, for example, the protocol described in Request For Comments 2608 entitled, “Service Location Protocol,” (E. Guttman et al., June 1999). The discovery of a service processor may include obtaining the network level address (e.g., Internet Protocol address), hostname, and port number where the external interfaces are accessible.

In an embodiment, the service processor has an introspection external interface that allows external entities to query an instance of the service processor for its supported external interfaces. Upon discovering the network level address and port number of the service processor, the full SOAP headers for the introspection interface can be constructed and an appropriate SOAP message sent to retrieve the set of interfaces supported by an instance. In an embodiment, the returned data contains details regarding the supported interfaces.

In an embodiment, the external interfaces are self-describing in the sense that they are described in a WSDL document that is accessible to an external entity. The WSDL document describing an interface may be stored on the platform or on a networked node remote from the platform. If the WSDL document is stored in a remote location, then a single WSDL document may be used to describe an interface that is found on more than one service processor.

In an embodiment, a messaging scheme is used for communications between a service processor and external entities using the services of the service processor. The reason messaging is used rather than, for example, remote procedure call (RPC) is that messaging provides platform independence and support for heterogeneous environments. The term “heterogeneous environments” refers to components that are implemented in different programming languages and/or are executing in different operating environments.

In one embodiment, external entities interact with the service processor by sending SOAP messages over a network interface. Each instance of the service processor exposes one or more external interfaces. Each of these interfaces is accessible at a specific Uniform Resource Indicator (URI). Each of these interfaces may be accessed by sending an HTTP “POST” message with SOAP headers containing the appropriate end point reference.

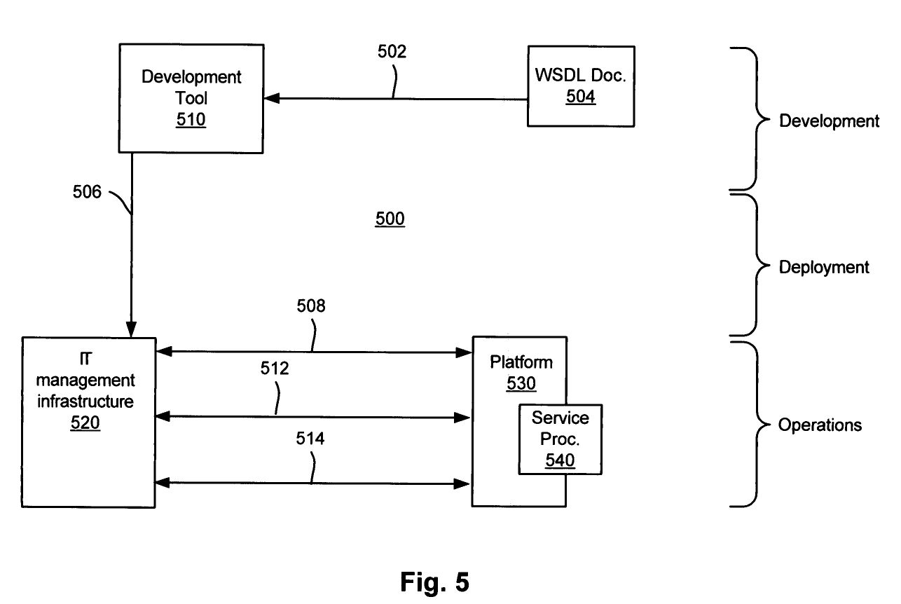

FIG. 5 is a block diagram illustrating selected aspects of discovering and extending a service processor according to an embodiment of the invention. Network 500 includes development tool 510, information technology (IT) management infrastructure 520, and platform 530 having service processor 540. Development tool 510 provides a software development environment for writing computer software. IT management infrastructure 520 broadly refers to one or more servers, consoles, and other infrastructure used to manage information technology.

Referring to 502, a developer defines the functionality and behavior of a new pluggable logic module and creates WSDL document 504 to describe its internal interfaces for external communication and invocation of the underlying operations. The developer may deploy WSDL document 504 onto infrastructure 520 as shown by 506. In addition, development tool 510 may generate interoperable client and server stubs based, at least in part on WSDL document 504. The developer can then expand the generated stubs with the code necessary to implement the desired server and client behaviors and semantics, while maintaining interoperability at the interface level.

The pluggable logic module code and WSDL document 504 may be distributed for operation and runtime use. The deployment mode for the newly developed capability may be either as built-in functionality for a service processor or functionality that is downloaded to the service processor. If the deployment mode is for built-in functionality, then the code that implements it is included in the service processor firmware. Otherwise it may be downloaded to a service processor using the appropriate administrative interfaces. In either case, if WSDL document 504 is intended to be stored locally on the service processor, it is included in the executable package for distribution. For implementations where a small service processor footprint is at a premium, WSDL document 504 can be stored elsewhere in infrastructure 520 or even on the Internet (e.g., provided it is accessible at development time and at run time).

Reference number 508 illustrates service processor discovery. Service processor discovery can by initiated by the service processor itself (e.g., on behalf of a managed node) or initiated by a management entity (e.g., IT management infrastructure 520). Discovered service processors may be included in a pool of managed resources. This typically implies inclusion in a management database and the ability to visualize an individual node's state and properties. Table 1 illustrates the two modes of service processor discovery.

TABLE 1

| Service Processor | | |
|---|---|---|
| Discovery | Description | Supporting Infrastructure |
| Service | Upon power up and | Implementations of |
| processor/Managed | connection to the | service processor |
| Platform | network used for | initiated discovery may |
| Initiated | management, the | include an announcement |
| | service processor | agent on the service |
| | announces itself to a | processor and an |
| | well-known node in, | announcement server in |
| | for example, IT | IT management |
| | management | infrastructure 520. |
| | infrastructure 520. | |
| | The well-known node | |
| | may be, for example, a | |
| | management console or | |
| | its announcement proxy | |
| | node. | |
| Manager Initiated | A management-server | Implementations of |
| | initiated discovery | manager initiated |
| | protocol is used by a | discovery may use, for |
| | management console or | example, the SLP |
| | its discovery proxy | protocol. |
| | node(s) in IT | |
| | management | |
| | infrastructure 520 to | |
| | discover the service | |
| | processor. | |

The discovery of the interfaces (and services) available on a service processor is illustrated at 512. In an embodiment, service processor 540 includes an introspection interface(s). The introspection interface(s) enable an external entity to inspect service processor 540 to determine the functionality it supports (or, more specifically, which external interfaces it provides). IT management infrastructure 520 can use the introspection interface(s) to dynamically inspect (and adjust) the functionality provided by service processor 540. This approach supports both dynamic runtime expansion of the functionality of service processor 540 and reduces the complexity of dealing with different profiles and corresponding configuration information that would otherwise need to be built into management consoles and kept up-to-date via software updates. The introspection invocation of service processor 540 returns endpoint references to access the services available on service processor 540 as shown by 514. An external entity can use the endpoint references to query data from or issue operational commands to service processor 540 and to the associated managed node on platform 530.

FIG. 6 is a block diagram illustrating selected aspects of sensor-effector interface (SEI) subsystem 600, according to an embodiment of the invention. SEI subsystem 600 provides a modular and extensible mechanism for managing platform hardware and software. Specifically, SEI subsystem 600 provides a common mechanism for interacting with managed hardware and software components on the host platform. SEI subsystem 600 incorporates the drivers for interacting with the platform hardware to enable a service processor to access and manipulate management-related information.

In an embodiment, SEI subsystem 600 provides a common abstraction of manageable platform features. That is, SEI subsystem 600 allows capability modules to access a single interface for managing the host platform by defining a common platform interface. Through this common interface, the capability modules can discover and identify manageable platform devices and firmware components and read their sensor data. In addition, the capability modules can configure their effectors and handle events generated by the managed entities. SEI subsystem 600 also accommodates controlled access to manageable platform features by determining which capability modules can access which manageable platform features and ensuring safe access to those features when allowed.

Hardware resource services 610 and software resource services 620 provide methods to read sensor data and/or set effector values. The methods provided by hardware resource services 610 and software resource services 620 may include: managed resource discovery operations, sensor/effector operations, and/or access synchronization operations. The managed resource discovery operations enable a capability module to determine what manageable resources exist on a platform. Examples of discovery operations include: run discovery process, get repository information (e.g., last update time, number of resources discovered, size, etc.), enumerate all resources, enumerate resources by type (e.g., enumerate entities vs. sensors vs. effectors), and/or enumerate resources by data type (e.g., enumerate only particular types of sensors effectors). The sensor/effector operations allow capability modules to interact with sensor data and set effector state. Examples of sensor/effector operations include: get sensor data, set effector data, and/or reset effector to default value. The synchronization operations allow a capability module to regulate access to a sensor or an effector. Examples of synchronization operations include: lock resource, unlock resource, and/or identify resource owners.

SEI providers 622 interact with the host platform by implementing code that can safely access the platform's manageable features. Communication channel drivers 650 provide access to managed resources 655 and 660. Communication channel drivers 650 include but are not limited to drivers for direct memory access via a system bus, a programmed I/O, a specialty bus, and/or an aggregator such as a system management bus (SMBus).

The illustrated examples of SEI providers 622 include Intelligent Platform Management Interface (IPMI) provider 625, mailbox provider 630, and memory scan provider 640. IPMI provider 625 accesses devices that support the IPMI specification. In an embodiment, mailbox provider 630 maps to any messaging protocol used to logically communicate with managed resources. Memory scan provider 640 accesses memory mapped device registers and host drivers via a direct memory access mechanism. Each of IPMI provider 625, mailbox provider 630, and memory scan provider 640 support a variety of operations including: resource discovery, send/receive, and/or event publication/subscription.

Managed hardware resources 655 represent one or more devices that are managed by the service processor. Managed hardware resources 655 are typically part of the managed node (e.g., managed node 110, shown in FIG. 1). In an embodiment, managed hardware resources 655 are accessible via either memory mapped, programmed I/O or SMBus and can provide a set of control registers relevant to the capability modules of the service processor. These control registers may ultimately be represented as sensors or effectors to the capability modules via SEI subsystem 600.

Since the service processor interacts with the managed node's devices, it is important that the service processor cooperates with the managed node. In those cases where devices may be accessed simultaneously by both the managed node and the service processor, it is useful to partition the manageable features of the device between the managed node and the service processor. Generally there are three categories of device sensors and effectors: those that are exclusively accessed by the managed node; those that are exclusively accessed by the service processor; and those that can be safely shared between both the managed node and the service processor. Special consideration is applied to devices that allow their registers to be used by both the managed node and the service processor. In general, these registers are intended for read-only access where read operations are fundamentally idempotent. That is, the act of accessing the register information will not affect the information contained therein. Thus, in an embodiment, read-affect register semantics are not allowed because they create contention between the managed node's device drivers and the service processor. The term “read-affect register semantics” refers to semantics in which accessing the register contents results in the contents being reset.

Managed software resources 660 include firmware modules and OS device drivers that interact with a service processor via SEI interface 605. This category of managed resources includes any platform component which is controlled directly by a host resident piece of software that is subsequently managed by the service processor. An example of this is a Network Interface Card (NIC) operated by a device driver running on a host OS. The NIC could have multiple managed software entities such as link state and various packet counts. SEI subsystem 600, in some cases, cannot manage these entities by directly accessing the NIC because this would create resource conflicts with the host's device driver trying to perform similar tasks. Instead, SEI subsystem 600 manages the software entity through the host device driver.

These components can be modeled in the same way as physical devices and made accessible to the service processor as an SEI provider. Mechanisms such as direct memory access (DMA) or programmed I/O may be used to provide communication with the software which owns the direct communication with the managed device. As with physical entities, care should be taken when interacting with the host's main memory and the logical entities that reside there. Specifically, if the memory access were through DMA, the physical memory address space (seen by the platform hardware) should equal the virtual memory address space (seen by the host's software) for the device driver data structures that are to be shared with the service processor.

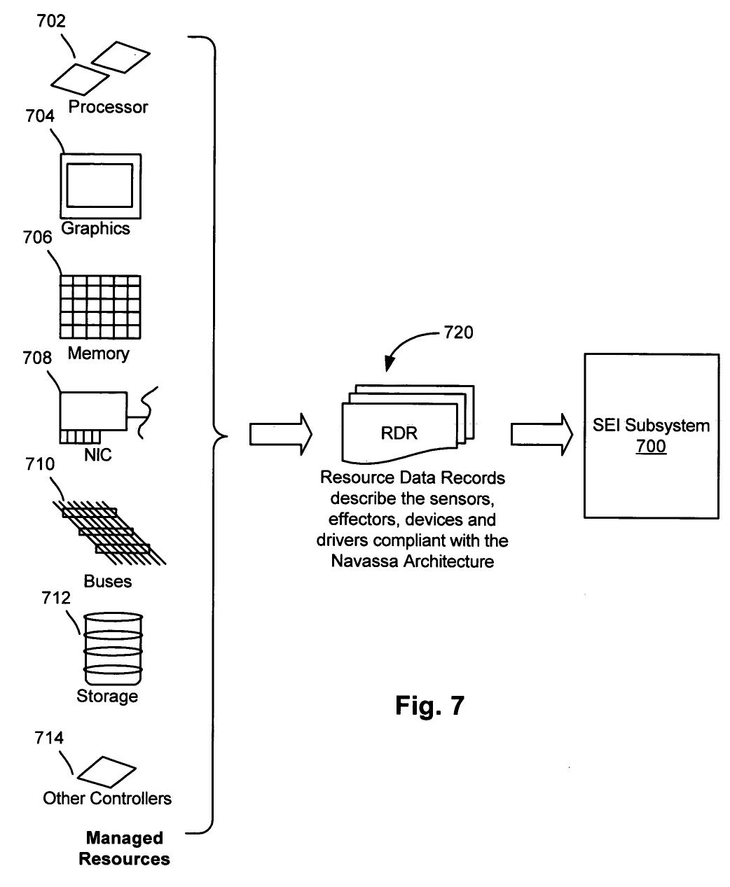

As is further described below with reference to FIG. 7, each managed resource may be described by a record containing managed data. In an embodiment, SEI providers 622 translate the managed data into a form consistent with the common abstraction of manageable platform features. The term “managed resource” refers to any managed entity (e.g., sensor and/or effector) that is described by managed data (e.g., described by a resource data record). A sensor refers to a read only resource. An effector refers to a controllable resource that takes one or more commands, institutes a change in the managed resource, and produces an output.

The managed data is presented, in an abstracted fashion, to capability modules running on the service processor via SEI interface 605. This logical abstraction provides three major benefits. First, it is a consistent mechanism for instrumenting the platform using a common namespace and access methods. Second, it provides a layer of protection that prevents capability managers from randomly accessing platform components or physical host memory that could cause system instability. Finally, it ensures system integrity by restricting possible actions to a confined set of operations that make sense for a particular sensor or effector.

FIG. 7 is a conceptual diagram illustrating a service processor gathering managed data from resource data records, according to an embodiment of the invention. Managed resources 702-714 represent the resources of a node that are managed by a service processor through SEI subsystem 700. In an embodiment, one or more of managed resources 702-714 have a corresponding Resource Data Record (RDR) 720. The purpose of RDRs 720 is to provide a consistent mechanism for describing managed resources 702-714. For example, each RDR 720 may specify a resource type and whether the resource can be a sensor, an effector, and the like. In addition, RDRs 720 may describe the relationships between managed resources 702-714 and the operations which can be performed on managed resources 702-714. RDRs 720 also provide a record identifier (ID) to identify a particular instance of a managed resource. The record ID can be used as a handle to access that particular resource through SEI subsystem 700. Depending on the type of managed resource, RDRs 720 can contain additional information such as the data type, location, path, or other attributes that together fully describe the managed resource. RDRs 720 can either be locally stored on a service processor or gathered by SEI Providers during the SEI discovery phase. Unlike previous system management technologies, RDRs 720 can be provided by the managed resources themselves enabling runtime discovery and maximizing extensibility of SEI subsystem 700.

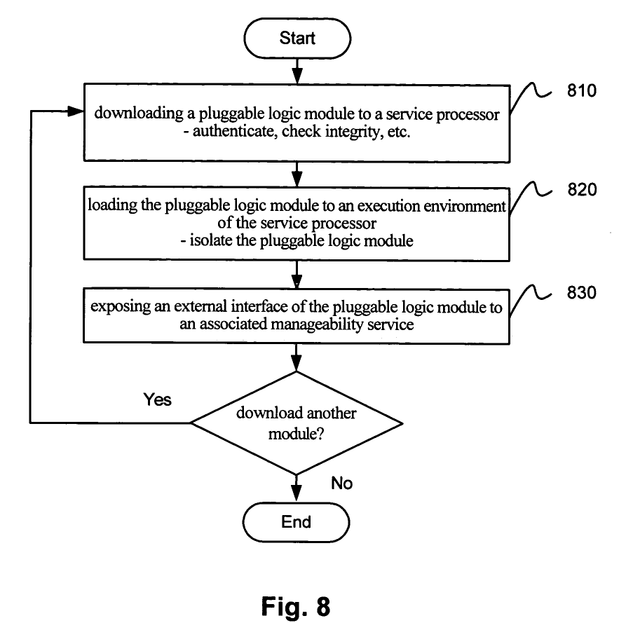

Turning now to FIG. 8, the particular methods associated with embodiments of the invention are described in terms of computer software and hardware with reference to a flowchart. The methods to be performed by a computing device (e.g., service processor implemented on a platform) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement embodiments of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 8 is a flow diagram illustrating certain aspects of a method for using a service processor, according to an embodiment of the invention. Referring to process block 810, a pluggable logic module is downloaded to a service processor (e.g., service processor 300, shown in FIG. 3). The term “downloading” broadly refers to receiving the pluggable module over a network (e.g., network 140, shown in FIG. 1). In an embodiment, the pluggable logic module is to provide logic for a manageability service. The term “manageability service” broadly refers to functionality to enable a service processor to manage a managed node (e.g., managed node 110, shown in FIG. 1). In an embodiment, the pluggable logic module is one of: a capability module (e.g., capability modules 122, shown in FIG. 1), a sensor-effector driver (e.g., sensor-effector drivers 123, shown in FIG. 1), and a service processor driver (also referred to as a self driver, e.g., self drivers 124, shown in FIG. 1).

In an embodiment, the pluggable logic module is downloaded using one or more security mechanisms. These security mechanisms may include and are not limited to: authenticating the source of the pluggable logic module and/or checking the integrity of the contents of the pluggable logic module. The security mechanisms may be implemented in at least partial compliance with any of a number of standards including, for example, the Organization for the Advancement of Structured Information Standards (OASIS) Standard 200401 entitled, “Web Services Security: SOAP Message Security 1.0 (WS-Security 2004),” March 2004 (hereinafter, the Web Services Security standard).

Referring to process block 820, the pluggable logic module is loaded to an execution environment (e.g., execution environment 126, shown in FIG. 1) of the service processor. The term “loading” broadly refers to placing at least a portion of the code corresponding to the pluggable logic module in the runtime memory of the execution environment. The term loading does not, however, necessarily imply transferring control to the loaded code. In an embodiment, the execution of the pluggable logic module is isolated on the service processor so that its malfunction will not affect the operation of the rest of the service processor. Module isolation may be provided through a number of possible mechanisms including software checking, type-safe language interpreter providing sandboxing, and/or hardware-based memory management.

Referring to process block 830, an external interface of the pluggable logic module is exposed. In one embodiment, the external interface is exposed as a web service. The term “exposing” an external interface broadly refers to making the interface visible and/or available to entities external to the service processor. Exposing the external interface may include allowing an external user to bind to and invoke the operations provided by the interface. In an embodiment, the service processor may support dynamic (runtime) binding to the interface. The term “dynamic binding” refers to binding to the interface without rebooting the service processor. In an embodiment, the external interface may be (optionally) invoked in a secure manner. For example, in an embodiment, the external interface may be invoked according to (or in partial accordance with) the Web Services Security standard.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. A platform comprising:
a managed node having at least one operating system; and
a service processor communicatively coupled with the managed node to provide manageability services for the platform, the service processor including an execution environment independent of the operating system and one or more pluggable logic modules to provide, at least in part, logic for the manageability services.

2. The platform of claim 1, wherein the execution environment is to provide one or more common services to the pluggable logic modules.

3. The platform of claim 1, wherein the pluggable logic module include one or more of:
a capability module to provide operational logic for the service processor;
a sensor-effector driver to access a resource of the managed node; and
a service processor driver to access a resource of the service processor.

4. The platform of claim 1, wherein the service processor comprises:
a platform-independent external interface subsystem to provide a communications link between the service processor and one or more management resources.

5. The platform of claim 4, wherein the external interface subsystem comprises:
an operations interface to enable an external entity to manage the managed node; and
an administration interface to enable an external entity to manage the service processor.

6. The platform of claim 5, wherein at least one of the operations interface and the administration interface is to interact with an external entity via a messaging protocol.

7. The platform of claim 6, wherein the messaging protocol is the Simple Object Access Protocol.

8. The platform of claim 6, wherein at least one of the operations interface and the administration interface is to be exposed as a Web service.

9. The platform of claim 6, wherein at least one of the operations interface and the administration interface is implemented as a capability module or in the execution environment.

10. The platform of claim 5, wherein at least one of the operations interface and the administration interface is a network-addressable entry point to access the service processor.

11. The platform of claim 10, wherein at least one of the operations interface and the administration interface is machine-discoverable via a discovery protocol.

12. The platform of claim 11, wherein the discovery protocol is the Service Location Protocol.

13. The platform of claim 5, wherein at least one of the operations interface and the administration interface is a self-describing interface.

14. The platform of claim 13, wherein the self-describing interface comprises an interface described by a Web Service Definition Language document.

15. The platform of claim 5, wherein the administration interface to enable an external entity to manage the service processor comprises:
an administration interface to download a new pluggable logic module to the service processor to provide additional logic for a manageability service.

16. The platform of claim 15, wherein the new pluggable logic module is one or more of:
a capability module to provide operational logic for the service processor;
a sensor-effector driver to access a resource of the managed node; and
a service processor driver to access a resource of the service processor.

17. The platform of claim 15, wherein the platform is one of:
a server, a desktop computer, a laptop computer, a network infrastructure device, a handheld computing device, and a cell phone.

18. A method comprising:
downloading a pluggable logic module at an external interface of a service processor, the service processor communicatively coupled with a managed node having at least one operating system, wherein the pluggable logic module is to provide, at least in part, logic for a manageability service; and
loading the pluggable logic module to an execution environment of the service processor, wherein the execution environment is independent of the operating system.

19. The method of claim 18, wherein the pluggable logic module is one of:
a capability module to provide operational logic for the service processor;
a sensor-effector driver to access a resource of the managed node; and
a service processor driver to access a resource of the service processor.

20. The method of claim 19, further comprising:
exposing an external interface of the pluggable logic module to an associated manageability service to enable an external resource to invoke an operation provided by the pluggable logic module.

21. The method of claim 20, wherein the external interface of the pluggable logic module is exposed without rebooting the service processor.

22. The method of claim 18, wherein downloading the pluggable logic module at the interface of the service processor comprises:
downloading the pluggable logic module at a platform-independent interface of the service processor.

23. The method of claim 22, wherein downloading the pluggable logic module at the platform-independent interface of the service processor comprises:
downloading the pluggable logic module at an administration interface the service processor.

24. The method of claim 22, wherein downloading the pluggable logic module at the platform-independent interface of the service processor comprises:
downloading the pluggable logic module using a security mechanism.

25. The method of claim 24, wherein downloading the pluggable logic module using a security mechanism comprises one or more of:
authenticating a source of the pluggable logic module; and
checking the integrity of the pluggable logic module.

26. The method of claim 22, further comprising:
isolating the pluggable logic module from one or more other pluggable logic modules within the execution environment of the service processor.

27. An article of manufacture comprising:
an electronically accessible medium providing instructions that, when executed by an apparatus, cause the apparatus to
download a pluggable logic module at an external interface of a service processor, the service processor communicatively coupled with a managed node having at least one operating system, wherein the pluggable logic module is to provide, at least in part, logic for a manageability service; and
load the pluggable logic module to an execution environment of the service processor, wherein the execution environment is independent of the operating system.

28. The article of manufacture of claim 27, wherein the electronically accessible medium provides further instructions that, when executed by the apparatus, cause the apparatus to:
expose an external interface of the pluggable logic module to an associated manageability service to enable an external resource to invoke an operation provided by the pluggable logic module.

29. The article of manufacture of claim 28, wherein the instructions that, when executed by the apparatus, cause the apparatus to expose the external interface of the pluggable logic module to the associated manageability service cause the apparatus to:
expose the external interface of the pluggable logic module without rebooting the service processor.

30. The article of manufacture of claim 27, wherein the instructions that, when executed by the apparatus, cause the apparatus to download the pluggable logic module at the interface of the service processor cause the apparatus to:
download the pluggable logic module at a platform-independent interface of the service processor.

31. A system comprising:
a managed node having at least one operating system;
a service processor communicatively coupled with the managed node to provide manageability services for the platform, the service processor including an execution environment independent of the operating system and one or more pluggable logic modules to provide, at least in part, logic for the manageability services; and
a Static Random Access Memory device communicatively coupled with the managed node.

32. The platform of claim 31, wherein the service processor comprises:
a platform-independent external interface subsystem to provide a communications link between the service processor and one or more management resources.

33. The platform of claim 32, wherein the pluggable logic module include one or more of:
a capability module to provide operational logic for the service processor;
a sensor-effector driver to access a resource of the managed node; and
a service processor driver to access a resource of the service processor.
